(19) United States
(12) Patent Application Publication
(10) Pub. No.: US 2004/0111533 A1
(43) Pub. Date: Jun. 10, 2004

(54) Transformations as web services

(75) Inventors: Michael Beisiegel, Poughkeepsie, NY (US); Piotr Przybylski, Brooklin (CA); Ilene Ruth Seelemann, Thornhill (CA); Norman K.W. Seto, North York (CA)

Correspondence Address: Leslie A. Van Leeuwen, International Business Machines Corporation, Intellectual Property Law Department, 11400 Burnet Road, Austin, TX, 78758, US

(73) Assignee: INTERNATIONAL BUSINESS MACHINES CORPORATION, Armonk, NY (US)

(21) Appl. No.: 10/378,380

(22) Filed: Mar. 3, 2003

(30) Foreign Application Priority Data
Dec. 6, 2002 (CA) 2,413,697

(51) Int. Cl. G06F 15/16

(52) U.S. Cl. 709/246; 715/513

(57) ABSTRACT

A transformation Web service description describes a Web service capable of receiving a message having a format compatible with a format of a message associated with a first Web service and transforming the message to a transformed message compatible with an input message format for a second Web service. The Web service description may be expressed in the Web services Description Language (WSDL). The Web service description includes a transformation description describing the transformation to be performed. The transformation description may be a programming language and platform neutral description such as an eXtensible Stylesheet Language Transform (XSLT) stylesheet and may be included within a transformer binding which extends WSDL. To support transformations involving multiple inputs and outputs, multiple input and/or output messages may be aggregated into a single multi-part input or output message, where each part has an attribute which references one of the multiple messages to be aggregated.

### FIELD OF THE INVENTION

The present invention relates to the field of Web services, and more particularly to the provision of transformations as Web services.

### BACKGROUND OF THE INVENTION

Web services are a relatively new form of World Wide Web (Web) application. A Web service is a collection of self-contained, self-describing, modular functions packaged as a single entity and published to a network for use by other programs. Web services are discoverable on a network and are capable of being remotely invoked from a web application regardless of the operating system and programming language in which they were developed. As a result, Web services facilitate the interoperability of applications across platforms and geographical distances.

Web services are commonly described using Web services Description Language (WSDL). WSDL is an extensible Markup Language (XML)-based language used to describe the capabilities of a Web service (i.e. the operations it provides), where it resides, and how to invoke it. WSDL permits clients to locate Web services and invoke any of their public operations. In WSDL, operations and their input/output messages are described in an abstract, platform-independent manner. These abstract descriptions are separately bound to concrete network protocols and data formats to facilitate actual use of the service.

A WSDL document describes a Web service using six major elements:

1. Types—a container for data types used in messages. Types are defined using a generic type system, e.g. XML Schema Definitions (XSDs).

2. Messages—abstract, typed definitions of the inputs and outputs of operations provided by the Web service. Each operation has one input message and one output message.

3. Port Types—abstract definition of publicly accessible operations provided by the Web service, supported by one or more endpoints. A port type may define one or more operations, each of which is an abstract definition of an action provided by the Web service. A port type may be likened to an interface in an object oriented programming language.

4. Binding—defines message format and protocol details for operations and messages defined by a particular port type. The binding takes its name from the fact that it “binds” abstract operations and message definitions with concrete communications/data format protocols. WSDL provides a generic format for describing a binding, as well as extensions of the generic format for commonly used bindings such as the Simple Object Access Protocol (SOAP) and HyperText Transfer Protocol (HTTP). As known by those skilled in the art, SOAP is a message protocol and data format specification defining a uniform way of performing remote procedure calls (RPCs) and passing data through encoding in XML when using HTTP as the underlying communications protocol.

5. Port—a combination of a network address (e.g. a URL) and a binding. A binding and port can bind an abstract interface (port type) to a particular Java™ or C++ application for example. The WSDL specification describes a generic format for describing a port. Ports are alternatively referred to as an “endpoints”.

6. Service—a collection of related endpoints.

A shortcoming of known Web services becomes apparent when a developer defining a new Web service wishes to invoke another Web service to provide some or all of the functionality of the new Web service. For example, a developer wishing to define a “telephone number lookup” Web service may wish to invoke an existing Web service which provides telephone number lookup functionality to minimize development efforts. Alternatively, a Web service developer may wish to aggregate a number of lower-level Web services to provide a new, higher-level Web service (e.g. to combine, say, car rental, air travel, or hotel Web services into a single high-level travel-related Web service). Disadvantageously, if the type of an input message to an existing Web service differs from the expected type of an input message to a new Web service, invocation of the existing service using an message input by the new Web service will be impossible due to a type mismatch between the messages.

A further problem in the case where a transformation has multiple inputs and outputs is the fact that specification of multiple inputs and/or multiple outputs for a single operation may not be supported. For example, WSDL only supports a single input and single output message per operation.

What is needed is a solution which addresses, at least in part, these or other shortcomings.

### SUMMARY OF THE INVENTION

A transformation Web service description describes a Web service capable of receiving a message having a format compatible with a format of a message associated with a first Web service (e.g. an input or output message of said first Web service) and transforming the message to a transformed message compatible with an input message format for a second Web service. The transformed message may be sent to the second Web service. The transformed message typically contains a reformatted version of at least some of the data of the original message. The Web service description may be expressed in the Web services Description Language (WSDL). The Web service description includes a transformation description describing the transformation to be performed. The transformation description may be a programming language and platform neutral description such as an extensible Stylesheet Language Transform (XSLT) stylesheet and may be included within a transformer binding which extends WSDL. To support transformations involving multiple inputs and outputs, multiple input and/or output messages may be aggregated into a single multi-part input or output message, where each part has an attribute which references one of the multiple messages to be aggregated.

In one aspect, there is provided a method of providing a Web service, comprising: receiving a message having a format compatible with a format of a message associated with a first Web service; and transforming the message to a transformed message compatible with an input message format for a second Web service.

In another aspect, there is provided a computer program product having media storing a Web service description describing a Web service capable of: receiving a message having a format compatible with a format of a message associated with a first Web service; and transforming the message to a transformed message compatible with an input message format for a second Web service.

In yet another aspect, there is provided a computer program product storing a Web service description comprising an aggregate message definition having a plurality of part elements, each part element including a reference to a message to be aggregated.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 is a schematic diagram of a computing system exemplary of the present invention;

FIG. 2 illustrates a Web services Description Language (WSDL) document associated with a Web service shown in FIG. 1;

FIG. 3 illustrates a WSDL document associated with another Web service shown in FIG. 1;

FIG. 4 illustrates an extensible Markup Language (XML) Schema shown in FIG. 1; and

FIGS. 5A and 5B illustrates a WSDL document associated with a transformation Web service shown in FIG. 1.

### DETAILED DESCRIPTION

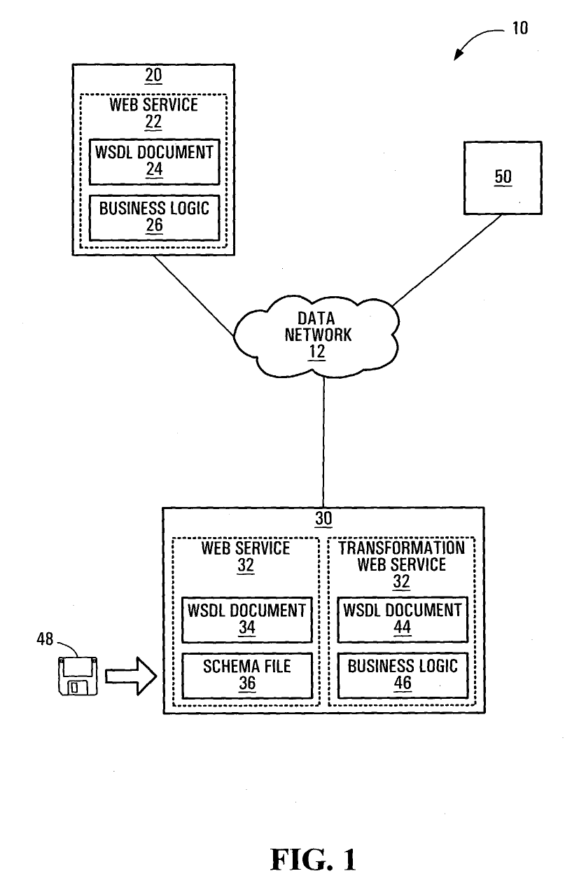

FIG. 1 illustrates a computing system 10 exemplary of the present invention. Computing system 10 includes three computing devices 20, 30 and 50 capable of intercommunication over a data network 12. The computing devices may be at distinct geographical locations. Each of computing devices 20, 30 and 50 is a network-aware computing device and as such includes a processor, memory, a network interface such as an Ethernet interface, a display and a keyboard (all not shown).

Data network 12 is the Internet in the present embodiment. However, in alternative embodiments, data network 24 may be a private local area network or any other type of data network known to those skilled in the art.

Computing device 20 hosts a Web service 22. Web service 22 is a postal code lookup service which receives a string representative of an address comprising a street name, street number and street type, and returns a string representative of the postal code for the received address. The Web service 20 includes a Web services Description Language (WSDL) document 24 as well as postal code lookup business logic 26 which interact conventionally to provide the Web service 22 in a manner known to those skilled in the art. Web service 22 may be referred to as the “existing” Web service.

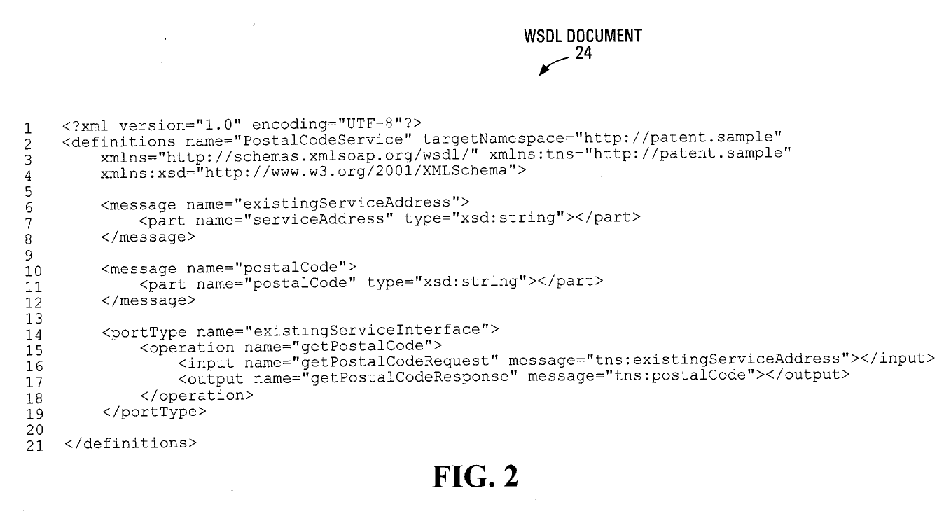

The WSDL document 24 describes the postal code lookup Web service 22 using WSDL. WSDL document 24 is illustrated in FIG. 2.

As shown in FIG. 2, the WSDL document 24 describes a single operation “getPostalCode” (at lines 15-18) having a single input message “existingServiceAddress” defined to be of type string (at lines 6-9) and a single output message “postalCode”, also defined to be a string (at lines 10-12). The WSDL document 24 further includes a binding element (not illustrated) which binds these operations and messages to a concrete data format and communications protocol. In the present embodiment, the binding element specifies the Simple Object Access Protocol (SOAP), which dictates that the Web service 22 is invoked using HTTP and eXtensible Markup Language (XML) data encoding, as will be familiar to those skilled in the art. Other bindings may be used in alternative embodiments.

Referring again to FIG. 1, postal code lookup business logic 26 is the proprietary executable code which actually performs the postal code lookup function of the Web service 22. Business logic 24 is coded in a chosen programming language (e.g. Java™) for a particular operating system platform (e.g. Windows®) executed by the computing device 20.

Computing device 30 hosts another Web service 32. Web service 32 is a postal code lookup service which receives an address object and returns a postal code object. The Web service 32 provides similar functionality to the existing Web service 22, i.e. it receives a street name, number and type and returns a postal code for the represented address. However, rather than receiving a single address string as input by the Web service 22, Web service 32 receives a record having three string fields representative of street number, street name, and street type, as will be described. Web service 32 may be referred to as the “new” Web service, as it has been created after the Web service 22 was already in existence.

The new Web service 32 includes a WSDL document 34 and an XML Schema 36.

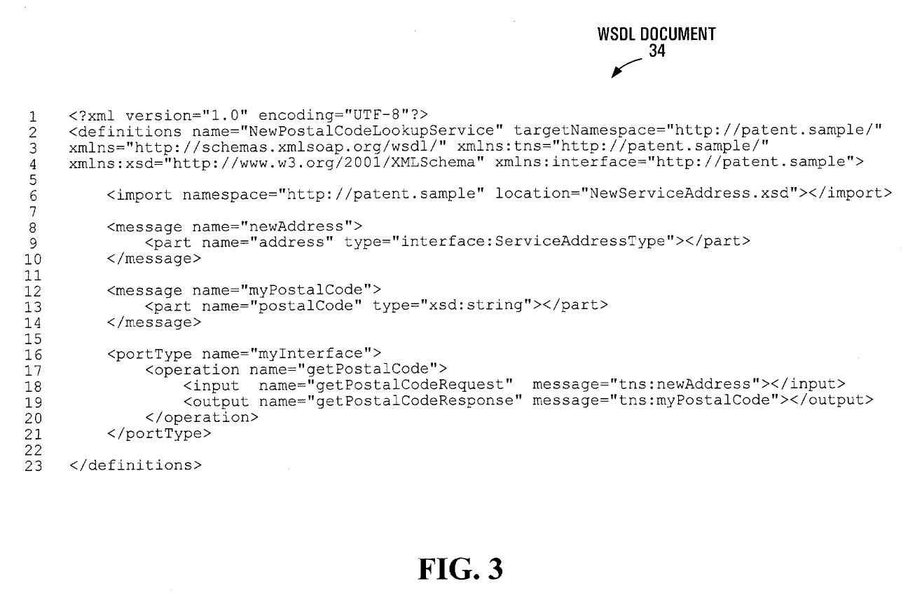

The WSDL document 34 describes the new postal code lookup Web service 32 using WSDL. WSDL document 34 is illustrated in FIG. 3.

As shown in FIG. 3, the WSDL document 34 describes a single operation “getPostalCode” (at lines 17-20) having a single input message “newAddress” defined to be of type “ServiceAddressType” (at lines 8-10) and a single output message “myPostalCode” defined to be a string (at lines 12-14). The type “ServiceAddressType” is defined in a separate XML Schema file 36 “NewServiceAddress.xsd” which is imported by the WSDL document 34 (at line 6).

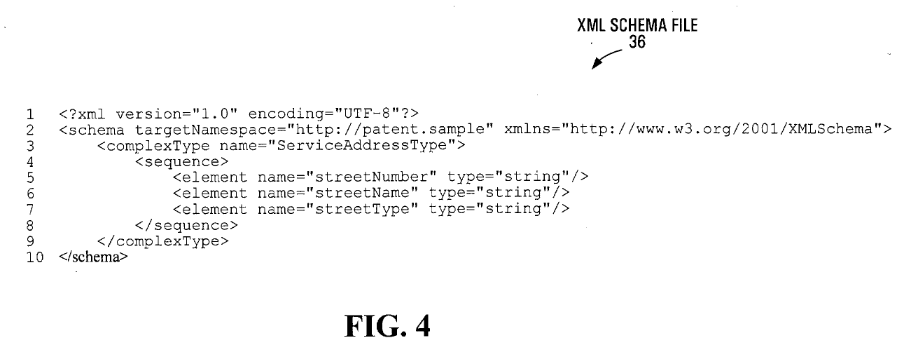

XML Schema file 36 is illustrated in FIG. 4. The XML Schema 36 defines the type “ServiceAddressType” of the input message to the new Web service 32 to be a complex type having three fields “streetNumber”, “streetName”, and “streetType”, which are all of type string. Objects of type “ServiceAddressType” thus have a record-like or structure-like composition, and may for convenience be referred to as records or structures.

Referring again to FIG. 1, client 30 further hosts a transformation Web service 42. Web service 42 is a transformation service which receives an address object record of type “ServiceAddressType” and transforms it into a string address object of equivalent semantic meaning. As will be described, transformation Web service 42 serves as an intermediate service for transforming data that is received by the new Web service 32 into the input format required by the existing Web service 22.

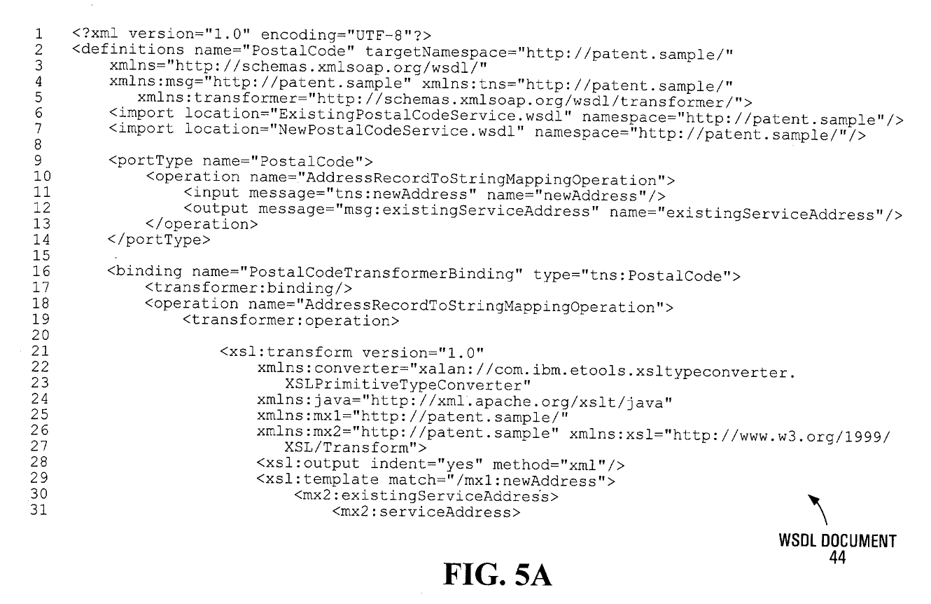

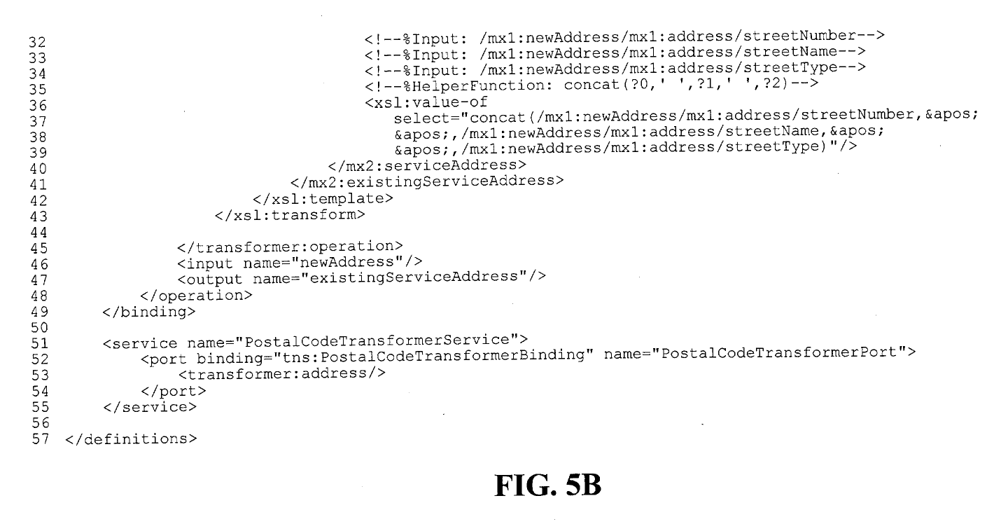

Web service 42 includes a WSDL document 44 (illustrated in FIGS. 5A and 5B) and business logic 46, which may be loaded from a computer program product having a readable medium, such as a removable optical or magnetic disk 48.

Referring to FIGS. 5A and 5B, WSDL document 44 defines a portType element “PostalCode” (at lines 9-14) with a single operation “AddressRecordToStringMappingOperation” (at lines 10-13). The “AddressRecordToStringMappingOperation” operation transforms objects of type “ServiceAddressType” into semantically equivalent objects of type string. In particular, the operation receives an input message “newAddress” (line 46 of FIG. 5B), which is defined in WSDL document 34 (FIG. 3) to be of type “ServiceAddressType”, and generates a semantically equivalent output message “existingServiceAddress” (line 47 of FIG. 5B), which is defined to be of type string in WSDL document 24 (FIG. 2). These definitions are imported by way of the import elements at lines 6 and 7 of WSDL document 44 (FIG. 5A).

To support the transformation service, a transformer binding “PostalCodeTransformerBinding” is defined within the WSDL document 44. The purpose of a transformer binding is to provide a description, within the context of a WSDL Web service definition, of the transformation that is to be performed by the Web service. Transformer bindings are an extension of WSDL.

Transformer binding “PostalCodeTransformerBinding” is defined at line 16 of FIG. 5A to line 49 of FIG. 5B. The transformer binding associates the operation “Address-RecordToStringMappingOperation” (referenced at line 18) with an eXtensible Stylesheet Language (XSL) Transform (XSLT) stylesheet declared at line 21 of FIG. 5A to line 43 of FIG. 5B. As known in the art, an XSLT stylesheet provides instructions on transforming one XML object into another XML object. In the present case, the XSLT stylesheet provides instruction on transforming a “ServiceAddressType” object to string object, specifically by concatenating the streetNumber, streetName and streetType fields of the former to create the latter (as shown in lines 32 to 39 of FIG. 5B). Because XSLT is used, the described transformation is programming language and platform neutral. That is, because XSLT describes a mapping between representations of data that are logical (versus concrete implementations thereof), the described transformation is language neutral. This is advantageous in that implementation of the transformation is not tied to a particular programming language or platform.

Business logic 46 is the proprietary executable code which actually performs the transformation function of Web service 42. Business logic 46 may be implemented by way of concrete classes which model the “AddressRecordToStringMappingoperation” and associated input and output messages and are invoked using the Web services Invocation Framework (WSIF) for example, as described in co-pending United States patent application titled “MAPPING BETWEEN NATIVE DATA TYPE INSTANCES” (CA 920020026).

In operation, an address object of type “ServiceAddressType” received as an input message of the new Web service 32 (FIG. 1), e.g. from a client at computing device 50, is sent to the transformation Web service 42 for transformation into an equivalent string address object. This transformation is effected by the business logic 46 of the Web service 42, in this case using concatenation as described above. The string address object is returned to new Web service 32 by the transformation Web service 42. The new Web service 32 then in turn sends the string address object to the existing Web service 22 at computing device 20 by way of data network 12. Web service 22 generates a postal code string object and returns same to the Web service 32 by way of network 12. This postal code string object is then returned to the caller as the output message of Web service 32. Advantageously, the new Web service 32 is able to utilize the existing business logic 26 of Web service 22 due to the transformation by transformation Web service 42 of the address information into a format expected by the Web service 22.

In another scenario, a transformation Web service may be used in conjunction with Web services that are “chained” together, i.e., a series of Web services where the output from one Web service forms the input to another Web service. For example, an Internet web site for electronically purchasing consumer products or other items may employ a first Web service for receiving a customer ID and password. This Web service may perform a lookup using the ID and password information provided by the client and thereafter output a corresponding customer record object comprising the customer's name, address, and account information. This record object may in turn be provided to a second and third Web service upon the customer's confirmation of a desired purchase. The second Web service may create an invoice, while the third Web service may order the desired item(s). If the data structures of these various Web services are not compatible, intermediate transformation services such as the one described above can be used to generate the desired data structures between Web service “stages”.

As should now be apparent, the portType element of a transformation Web service such as transformation Web service 42 defines the operation for the transformation function. The operation references an input and output message “msgln” and “msgOut” which describe the input and the output values for the transformation function respectively, as follows:

```
<portType name=“TranformerOperations”>
    <operation name=“MsgInToMsgOut”>
    <input name=“input” message=“msgIn” />
    <output name=“output” message=“msgOut” />
    </operation>
</portType>
```

Of course, a portType in a transformation Web service (as in any Web service) may contain multiple operations, each of which defines a transformation function, with each operation having a corresponding binding operation in the binding second of the WSDL document.

The elements of the transformer binding which extend WSDL are shown below (these elements being identifiable by the “transformer:” prefix):

```
<binding name=“TranformerBinding”, type=“TransformerOperations”>
<transformer:binding />
    <operation name=“MsgInToMsgOut”>
    <transformer:operation>
    ... XSLT describing the mapping from
    ... MsgIn to MsgOut to be inserted here
    </transformer:operation>
    </operation>
</binding>
<service name=“TransformerService”>
    <port name=“TranformerPort” binding=“TranformerBinding” >
        <transformer:address ... />
    </port>
</service>
```

Each binding operation contains a transformer operation which contains the XSLT stylesheet that describes the transformation of the input to the output.

In order to support transformations involving multiple inputs and outputs, multiple input messages may be aggregated into a single multi-part message in which each part references one of the multiple messages to be aggregated by way of a “message” attribute of the part element. This is possible because the WSDL specification (available at http://w3.org/tr/WSDL and incorporated by reference hereinto) allows the definition of additional message-typing attributes. For example:

```
<message name=“Msg-N” >
    <part name=“msg_l” message=“Msg-i” />
    <part name=“msg_l” message=“Msg_2” />
    ...
    <part name=“msg_n” message=“Msg_n” />
</message>
```

The aggregate message may be used as an input to the transformation Web service, e.g.:

```
<portType name=“TranformerOperations”>
<operation name=“MsgXInToMsgOut”>
    <input name=“input” message=“Msg_N” />
    <output name=“output” message=“Msgout” />
</operation>
</portType>
<binding name=“TranformerBinding” type=“TransformerOperations”>
<transformer:binding />
<operation name=“MsgxInToMsgOut”>
    <transformer:operation>
    ... XSLT describing the mapping
    ... from Msg_N to MsgOut
    </transformer:operation>
</operation>
</binding>
<service name=“TransformerService”>
<port name=“TranformerPort” binding=“TranformerBinding” >
    <transformer:address ... />
</port>
</service>
```

Multiple output messages may be similarly aggregated into a single output message having multiple parts. This may be done by defining each part of the aggregate message to have a message attribute which references one of the messages to be aggregated. It will be appreciated that this typically increases the complexity of the contained XSLT stylesheet as compared to the non-aggregated message case.

As will be appreciated by those skilled in the art, modifications to the above-described embodiment can be made without departing from the essence of the invention. For example, Web services 22, 32 and 42 are not necessarily allocated among computing devices 20 and 30 as shown in FIG. 1. The Web services can be allocated among computing devices 20 and 30, or other computing devices such as computing device 50, in a different arrangement. For example, all of the Web services may be hosted on the same computing device. Alternatively, each Web service can be hosted on a different computing device 20, 30 and 50.

Referring still to FIG. 1, business logic 26 does not necessarily reside on the same computing device as WSDL Document 24. Similarly, WSDL document 34 and Schema file 36 may reside on different computing devices. Further, WSDL Document 44 and business logic 46 could be hosted on different computing devices which may not host any of the other items presently illustrated as residing on computing device 30.

Network 12 need not necessarily be capable of supporting HTTP, unless a binding of the Web service 22 or 32 specifies HTTP as the underlying data communications protocol.

Although the transformation Web service 42 transforms a received object into a semantically equivalent object in the above description, it is understood that semantic equivalence of the input object and output object is not required. For example, elements or attributes present in an input object may be omitted from an output object generated therefrom.

Also, because Web services defined using languages other than WSDL may not define bindings or include binding elements, it will be appreciated that constructs other that a transformer binding may be used to describe transformations. These constructs may or may not include XSLT stylesheets.

Also, while the transformer binding presently extends WSDL, it is conceivable that a transformer binding may comprise WSDL in future WSDL versions.

Other modifications will be apparent to those skilled in the art and, therefore, the invention is defined in the claims.

What is claimed is:

1. A method of providing a Web service, comprising:
receiving a message having a format compatible with a format of a message associated with a first Web service; and
transforming said message to a transformed message compatible with an input message format for a second Web service.

2. The method of claim 1 further comprising:
sending said transformed message to said second Web service.

3. The method of claim 2 wherein said transformed message contains at least some message data contained in said message.

4. The method of claim 3 wherein said message is an input message of said first Web service.

5. The method of claim 3 wherein said message is an output message of said first Web service.

6. The method of claim 3 wherein at least one of said message and said transformed message comprises a plurality of aggregated messages.

7. The method of claim 6 wherein said at least one of said message and said transformed message is a multi-part message and each said aggregated message comprises one part.

8. A computing device comprising a processor and persistent storage memory in communication with said processor storing processor readable instructions for directing said device to undertake the method of any of claims 1 to 7.

9. A computer program product having media including computer programmed instructions for directing a computing device to implement the method of any of claims 1 to 7.

10. A computer program product having media storing a Web service description describing a Web service capable of:
receiving a message having a format compatible with a format of a message associated with a first Web service; and
transforming said message to a transformed message compatible with an input message format for a second Web service.

11. The computer program product of claim 10 wherein said Web service description comprises a transformation description which describes said transforming.

12. The computer program product of claim 11 wherein said transformation description is programming language and platform neutral.

13. The computer program product of claim 12 wherein said transformation description is an extensible Stylesheet Language Transform (XSLT) stylesheet.

14. The computer program product of claim 10 wherein said Web service description comprises Web services Description Language (WSDL).

15. The computer program product of claim 14 wherein said WSDL description includes a transformer binding comprising a transformation description describing said transformation, said transformer binding comprising WSDL or an extension of WSDL.

16. The computer program product of claim 15 wherein said transformation description is programming language and platform neutral.

17. The computer program product of claim 16 wherein said transformation description is an XSLT stylesheet.

18. A computer program product storing a Web service description comprising an aggregate message definition having a plurality of part elements, each said part element including a reference to a message to be aggregated.

19. The computer program product of claim 18 wherein each said reference comprises an attribute identifying said message to be aggregated.
